(19) United States
(12) Patent Application Publication
(10) Pub. No.: US 2005/0163924 A1
(43) Pub. Date: Jul. 28, 2005

(54) Porous surfactant mediated metal oxide films

(75) Inventors: Mark T. Anderson, Woodbury, MN (US); Jimmie R. Baran JR., Prescott, WI (US); Tadesse G. Nigatu, Maplewood, MN (US); Mark J. Pellerite, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/040,746

(22) Filed: Jan. 21, 2005

Related U.S. Application Data
(62) Division of application No. 10/245,216, filed on Sep. 17, 2002, now abandoned.

(51) Int. Cl. G03C 1/76

(52) U.S. Cl. 427/166

(57) ABSTRACT

The present invention provides surfactant mediated metal oxide films that are hydrophilic and articles having hydrophilic films of the invention on one or more surfaces.

### CROSS REFERENCE TO RELATED APPLICATIONS

This application is a divisional of U.S. application Ser. No. 10/245,216, filed Sep. 17, 2002, the disclosure of which is herein incorporated by reference.

### FIELD

The present invention relates to supported porous metal oxide films that are hydrophilic.

### BACKGROUND

Hydrophilic surfaces are desirable for their antifogging behavior. “Antifogging” means broadly the art of preventing or minimizing the occurrence of optical distortions resulting from fogging, growth of condensate droplets, or water droplets that otherwise adhere to a surface.

Many surface treatments have been proposed with varying degrees of success. For example, applications of hydrophilic or hydrophobic compounds have been used to provide antifogging surfaces. However, the antifogging effect is temporary since compounds such as polyethylene glycol and silicone may be removed relatively easily when exposed to water. Various types of surfactants have also been proposed. However, surfactants have also proved to be temporary.

U.S. Pat. No. 6,013,372 reports hydrophilic, antifogging coatings containing titania. The coatings are generally made by depositing compositions containing a titania source, an acid and a solvent, onto a substrate, drying the composition, and then calcining. The coating compositions may also contain particles of silica or tin.

U.S. Pat. No. 5,858,457 reports a method for making highly ordered, porous, supported surfactant templated metal oxide films. The coatings are reported to have Bragg peaks in the X-ray diffraction (XRD) pattern of from 2-6° two-theta using Cu K_{α} radiation.

PCT Publication No. WO 99/37705 reports surfactant templated metal oxide materials that are highly ordered and have a large pore size.

### BRIEF DESCRIPTION OF THE FIGURES

FIG. 1 shows X-Ray Diffraction patterns for Comparative Example 1 and Sample 6 of Table 5.

FIG. 2 shows a digital image of a high resolution field emission scanning electron micrograph of surfactant-mediated titania representative of Samples 1 A-1 I of Table 9.

FIG. 3 shows a digital image of a high resolution field emission scanning electron micrograph of sol-gel formed titania representative of Comparative Examples CE2 A-CE2 I.

### SUMMARY

In one aspect, the invention provides surfactant mediated metal oxide films. The surfactant mediated metal oxide films of the invention are nanoporous and provide no XRD peaks at less than 5° 2θ (that is, when present peaks are only at 5° 2θ and above) using Cu Kα radiation. The surfactant mediated metal oxide films of the invention have a highly un-ordered porosity.

A “surfactant mediated film” means a nanoporous film that does not exhibit long range order of its pores, has porosities of greater than 20% (desirably, greater than 50%), is continuous (substantially no discontinuities, for example cracks), has greater than 50% (desirably, greater than 90%) of nanopores in the range of 0.1 to 50 nm (desirably, 1 to 10 nm) pore size, and the surfactant mediated films of the invention are desirably transparent. Surfactant mediated films do not provide low-angle Bragg peaks when analyzed using XRD using Cu Kα radiation. The pores of surfactant mediated films of the invention are accessible from the surface of the films as the surfaces are nano-roughened.

In contrast, “surfactant templated films” provide low angle peaks when analyzed using Cu Kα radiation and exhibit long range order of their pores. In many cases, a large fraction of the pores of surfactant templated films are not accessible from the surface of the film.

The surfactant mediated films of the invention can provide surfaces that are super hydrophilic and demonstrate contact angles with water of less than 10°, preferably less than 5°. The low contact angles of the films of the invention generally persist longer that those of films made from sol-gel processes and certain films of the invention, for example, titania, regenerate faster under exposure to UV light. “Regeneration” is shown by a change in contact angle from greater than 10° to less than 10°. In addition, surfactant-mediated films exhibit less intense interference colors than more dense films due to the high porosity and lower refractive indices of surfactant-mediated films. This provides films having lower surface coloration at viewing angles.

### DETAILED DESCRIPTION

The surfactant mediated metal oxide (SMM) films of the invention are generally made by coating a SMM precursor composition onto a substrate, evaporating the solvent to form a thin metal oxide-surfactant film, and removing the surfactant.

The SMM precursor compositions are made by choosing reagents and conditions such that the surfactant does not rigorously template (order) the inorganic phase, but imparts a random nanoporosity to the inorganic phase such that the volume percent porosity is greater than about 20% and desirably greater than about 50%. Reagents and conditions are generally chosen so that the spontaneous surfactant ordering that occurs on drying of the coated precursor composition does not dominate the overall structure-direction. This can be accomplished by choosing alkoxides that rapidly hydrolyze and condense (e.g., titanium ethoxide in the presence of hydrochloric acid and water) so that the random, fractal sol-gel reaction competes with the spontaneous order of the surfactant into an liquid crystalline structure, or by choosing conditions such that the surfactant is a marginal liquid crystal former (e.g., a temperature near the Krafft point, or at high temperature where long-range order is disrupted by thermal effects, or with a cosolvent/additive, such as an intermediate chain length alcohol with an alkyl ammonium surfactant, that disrupts the order of micelles).

The SMM precursor compositions contain a soluble source of metal oxide. Examples of soluble sources of metal oxide include titanium alkoxides such as titanium butoxide, titanium isopropoxide, titanium ethoxide, titanium peroxide, and titanium diisopropoxide bis(2,4-pentanediaonate); and alkoxysilanes such as tetramethoxysilane and tetraethoxysilane; and combinations thereof. Other sources include alkoxides and molecular salts of metals such as zirconium, hafnium, vanadium, molybdenum, tungsten, manganese, iron, cobalt, nickel, copper, zinc, aluminum, gallium, indium, germanium, tin, arsenic, and antimony.

The SMM precursor compositions contain one or more surfactant mediating agents (surfactants). The surfactant mediating agents may be cationic, nonionic, or anionic, and may also be fluorinated. Useful cationic surfactants include alkylammonium salts having the formula CₙH₂ₙ₊₁N(CH₃)₃X, where X is OH, Cl, Br, HSO₄ or a combination of OH and Cl, and where n is an integer from 8 to 22, and the formula CₙH₂ₙ₊₁N(C₂H₅)₃X, where n is an integer from 12 to 18; gemini surfactants, for example those having the formula: (C₁₆H₃₃N(CH₃)₂)₂ CₘH₂ₘ2X, wherein m is an integer from 2 to 12 and X is as defined above; and cetylethylpiperidinium salts, for example C₁₆H₃₃N(C₂H₅)(C₅H₁₀)X, wherein X is as defined above.

Useful anionic surfactants include alkyl sulfates, for example having the formula CₙH₂ₙ₊₁OSO₃Na, where n is 12 to 18; alkylsulfonates including C₁₂H₂₅C₆H₄SO₃Na; and alkylcarboxylic acids, for example C₁₇H₃₅COOH and C₁₄H₂₅COOH.

Other useful anionic surfactants include, but are not limited to, alkali metal and (alkyl)ammonium salts of: 1) sulfates of polyethoxylated derivatives of straight or branched chain aliphatic alcohols and carboxylic acids; 2) alkylbenzene or alkynaphthalene sulfonates and sulfates such as sodium octylbenzenesulfonate; 3) alkylcarboxylates such as dodecylcarboxylates; and 4) ethoxylated and polyethoxylated alkyl and aralkyl alcohol carboxylates.

Useful nonionic surfactants include poly(ethylene oxides), (octaethylene glycol) monododecyl ether (C₁₂EO₈), (octaethylene glycol) monohexadecyl ether (C₁₆EO₈), and poly(alkylene oxide) triblock copolymers such as poly(ethylene oxide)-poly(propylene oxide)-poly(ethylene oxide) (PEO-PPO-PEO) or the inverse (PPO-PEO-PPO). Examples of useful commercially available nonionic copolymer surfactants include those having the tradename PLURONIC and product designations P123, F98, 25R4, and 17R4, available from BASF Corporation, Mount Olive, N.J.

Another useful class of organic templating agents is the ethoxylated amines also called ethoxylated fatty amines. Preferred ethoxylated amines have the formula R—N(CH₂CH₂O)ₓH (CH₂CH₂O)_{y}H, wherein x+y=15 and 50 and are commercially available from Akzo Nobel, Chicago, Ill., under the trade designation ETHOMEEN.

Organic solvents may be used in the SMM precursor compositions. Useful organic solvents include alcohols, such as ethanol, methanol, isopropanol and other moderately high dielectric constant solvents such as ketones, furans, amides, polyols, nitrites, including acetone, tetrahydrofuran, N-methylformamide, formamide, glycerol, acetonitrile, ethylene glycol, and mixtures thereof. Water used in the SMM compositions is typically deionized.

The SMM compositions may contain one or more acid catalysts. Useful acid catalysts include organic and inorganic acids. Specific examples include acetic acid, nitric acid, and hydrochloric acid.

In some embodiments, the SMM precursor compositions and the resulting films may contain nanoparticles. Useful nanoparticles include, for example, metal oxides of silicon, titanium, aluminum, antimony, arsenic, zirconium, tin, and rare earth and transition metal oxides. Specific examples include colloidal silica and titania nanoparticles. Specific examples include Nalco 1042 (20 nm) colloidal silica, from Nalco Chemical Co., Naperville, Ill.; 8, 9, and 12 nm Optolake titania particles, from Catalyst and Chemicals Ind. Co. Ltd., Kawasaki City, Japan; and 30 nm titania/antimony particles prepared by combining a soluble source of titania with a soluble source of antimony and subjecting the combined sources to heat and pressure in an autoclave between 150 and 200° C. for 5 hours as described in U.S. application Ser. No. 09/990,604, filed Nov. 21, 2001, incorporated by reference herein.

Generally, the molar ratios of the components in the compositions range from about 20 to about 140 moles solvent, about 0.1 to about 26 moles water, about 0.001 to about 1.0 moles surfactant-mediating agent, per mole of metal oxide. In other embodiments, the molar ranges are from about 40 to about 60 moles solvent, about 0.1 to about 5 moles water, and about 0.05 to about 0.4 moles catalyst per mole of metal oxide. The metal oxide to surfactant volume ratio is generally in the range of from 10 to 0.1. Nanoparticles may be used in the SMM precursor compositions up to about 30 volume percent.

The SMM films of the invention typically have a thickness in the range of from 10 nm to about 1 micrometer and may be any thickness or range of thicknesses therebetween; and/or have a porosity of from about greater than 20% to about 90%, desirably from greater than 50% to 90%; and/or a refractive index of from about 1.2 to about 2.15 (and any range or single refractive index between 1.2 and 2.15) without nanoparticles and from about 1.35 to up to about 2.1 (and any range or single refractive index between 1.35 and 2.1) with nanoparticles. Films having a porosity greater than about 50% typically have refractive index of less than 1.7.

SMM films of the invention are made by coating a SMM precursor composition of the invention onto a surface. The SMM precursor composition may be coated onto the surface by any known means such as dip-coating, spin-coating, spray coating, or gravure coating. The coated surface is allowed to dry at room temperature or optionally, heated at slightly elevated temperature. Once the coating is substantially dry, the coating may be treated in a manner so to remove substantially all of the surfactant mediating agent.

Typically, the metal oxide-surfactant film is calcined at a sufficient temperature for a sufficient time to form the SMM film by removing the surfactant-mediating agent. Typical calcining temperatures range from about 200° to about 850° C. including any temperature and temperature range in between 200° C. and 850° C. Typical calcining times range from about 0.01 to about 10 hours and any time and time range between 0.01 to 10 hours, including from about 0.5 to about 2 hours. The actual calcining time will vary depending on the type and amount of surfactant used.

The SMM films of the invention may be used on a wide variety of substrates where hydrophilicity and/or antireflection would be a useful characteristic of the surface of the substrate. These include substrates made from metals, painted metals, glass, ceramics, wood, and the like. Examples of such substrates include mirrors, lenses, eyeglasses, optical components, instrument covers, signage, windows, tile, retroreflective articles, metals, windshields, face shields, and various medical equipment and supplies. The SMM films described herein may also be used as one or more layers in an antireflective stack.

The surfaces of substrates may also have an inert barrier film between the substrate surface and the SMM film. Examples of such inert films include those comprising silica or silicone. For example, such inert films would provide a barrier between a surfactant-mediated titania film and a glass substrate, preventing migration of alkali metals from the glass into the titania.

### EXAMPLES

Glossary

10R5 is a PPO-PEO-PPO triblock copolymer surfactant, available from BASF under the trade designation “PLURONIC 10R5”.

P123 is a PEO-PPO-PEO triblock copolymer surfactant, available from BASF under the trade designation “PLURONIC P123”.

P103 is a PEO-PPO-PEO triblock copolymer surfactant, available from BASF under the trade designation “PLURONIC P103”.

“C₁₆TAB” is cetyltrimethylammonium bromide, available from Aldrich Chemical Company, Milwaukee, Wis.

“C₁₄TAB” is tetradecyltrimethylammonium bromide, available from Aldrich Chemical Company.

### General Methods

Substrate Cleaning Procedure

Glass substrates (VWR MicroSlides, precleaned 25×75 mm, VWR Scientific Inc, West Chester, Pa.) and ≦100≧ cut, p-type, B-doped silicon wafers (3″ from Silicon Sense, Nashua, N.H.) were cleaned by sonicating in a LIQUINOX/deionized water solution for 2 minutes. The substrates were then rinsed with deionized water for 2 minutes and rinsed with ethanol prior to coating.

2.16 M TEOS Sol

Tetraethoxysilane (TEOS) (223 μL, available from Aldrich Chemical Company); absolute ethanol (223 mL, available from Aaper Alcohol, Shelbyville, Ky.); deionized water (17.28 mL); and 0.07 N hydrochloric acid (0.71 mL) were combined in a 2-L reaction flask. The resulting transparent solution was heated to 60° C. and stirred for 90 minutes. The solution was allowed to cool and was transferred to a plastic bottle and stored in a 0° C. freezer. The solution is predicted to be stable for greater than 5 years. The resulting solution had a concentration of 2.16 M SiO2.

Thickness (t) and Refractive Index (n)

Data (psi and delta) were measured on SMM films on silicon wafers at 50° and 70° with a Gaertner L116A ellipsometer (Skokie, Ill.) that employs a HeNe 632 nm laser. At least three spots were measured for each sample. Reported values are averages. Thickness and refractive index were determined by assuming a single layer film from psi and delta with software provided by the vendor. Parameters for the substrate were index Ns=3.850, absorption coefficient Ks=−0.020.

Contact Angles (CA)

Static water contact angles were collected using a VCA 2500 XE, available from AST Products (Billerica, Mass.). Typically, a 1 microliter droplet of deionized water was transferred to the substrate and after 10 seconds a digital image of the spread water droplet was recorded. Internal software was used to automatically determine contact angles. For contact angles less than 15°, it was sometimes necessary to manually determine contact angles owing to inability of the software routine to properly identify the edges of the droplet of water. At least two water droplets were used for each substrate. Data were averaged. For dip-coated films on glass, the contact angles on the top and bottom of the substrate were recorded.

X-Ray Diffraction (XRD)

Low angle diffraction data were collected using a high resolution diffractometer, copper K_{α} radiation, and scintillation detection of the scattered radiation. For examining the crystallinity of titania (20-60° 2θ), data were collected using a Philips APD vertical diffractometer, copper K_{α} radiation, reflection geometry, and proportional detector.

Photocatalytic Activity Testing (PA)

A 4×10⁻⁴ M sodium terephthalic acid in water was prepared. This solution (100 mL) was added to a 500 mL crystallization dish along with a magnetic stir bar. One 25×75 mm SMT-coated glass substrate was added to each dish. The samples were immediately placed under a ˜2.0 mW/cm² UV source (UVB Black-Ray Lamp Model XX-15L (Upland, Calif.)) with stirring. Aliquots (1 mL) were removed every 5 minutes and the fluorescence from 2-hydroxyterephthalic acid was analyzed with a spectrophotometer (Spex FluoroMax-3, JY Horiba, Spex Fluorescence Division, Edison, N.J.). The spectrometer had a 315 nm excitation source; fluorescence at 424 nm was monitored. The intensity versus time data were plotted and the data were fit with a linear function. These data are referred to as “initial slope”; a higher slope indicates a more active material.

Pencil Hardness

Data were determined using a Wolff-Wilborn pencil testing apparatus from Gardco (Pompano Beach, Fla.) according to ASTM D3363-92a and ECCA T4 (1984). Seventeen pencil leads that range from 6B to 9H were available for testing.

Weathering Data

SMM films on glass were tested according to ASTM G-155, Cycle 1 where the UV source was a Xenon arc-lamp; the cycle time was 102 minutes with a daylight filter (0.35 W/m²/nm at 340 nm) at a temperature of 62° C. followed by 18 minutes of exposure to daylight with water spray; and the total test time was 500 hours.

Volume Percent Surfactant (V % surf)

The approximate volume ratio of surfactant (S) relative to inorganic (I) of a SMM precursor composition was determined as follows:
V % surf=100×(V_{S}/(V_{S}+V_{I})) (1)
where V_{S} was determined from the formula weight and density (assumed to be 1 g/cc) of the surfactant, and V_{I} is determined based on the moles, formula weight, and density of the metal oxide (e.g., for titania as anatase, FW=79.88 g/mol and density=3.84 g/cc). The formula is V_{I}=moles*FW/density.
Porosity (% P)

Fraction porosity was calculated from refractive index data according to the Lorentz-Lorenz equation:
P=1-[((nₐₙₐₜₐₛₑ²−1)/(nₐₙₐₜₐₛₑ²+2))/((n_{calc}²−1)/(n_{calc}²+2))] (2)
where nₐₙₐₜₐₛₑ is 2.53 and n_{calc} is the refractive index of the calcined film as determined by ellipsometry. In the case where there was a mixed-metal oxide framework, the molar average refractive index was used. A value of n=1.458 was used for the index of silica.

Percent porosity is:
% P=100*P (3)

### Example 1

Titanium ethoxide (Aldrich Chemical Company), absolute ethanol, P123, and concentrated hydrochloric acid were mixed in a 250 mL polypropylene bottle in the amounts shown in Table 1. The mixture was stirred at 300 rpm at room temperature prior to coating. The mixtures all formed transparent colorless solutions.

TABLE 1

| Example 1 | Ti(OC₂H₅)₄ | | | |
|---|---|---|---|---|
| (Sample) | (mL) | Ethanol (mL) | P123 (g) | HCl (mL) |
| 1 | 7.59 | 77.2 | 0.25 | 0.57 |
| 2 | 7.59 | 77.2 | 0.5 | 0.57 |
| 3 | 7.59 | 77.2 | 1 | 0.57 |
| 4 | 7.59 | 77.2 | 2 | 0.57 |
| 5 | 7.59 | 77.2 | 3 | 0.57 |
| 6 | 7.59 | 77.2 | 4 | 0.57 |
| 7 | 7.59 | 77.2 | 5 | 0.57 |

The molar ratios of the reagents are shown in Table 2.

TABLE 2

| | Ti | Ethanol | P123 | HCl | Water |
|---|---|---|---|---|---|
| Sample | (mol) | (mol) | (mol) | (mol) | (mol) |
| 1 | 1 | 35.7 | 0.0012 | 0.188 | 0.650 |
| 2 | 1 | 35.7 | 0.0024 | 0.188 | 0.650 |
| 3 | 1 | 35.7 | 0.0047 | 0.188 | 0.650 |
| 4 | 1 | 35.7 | 0.0094 | 0.188 | 0.650 |
| 5 | 1 | 35.7 | 0.0142 | 0.188 | 0.650 |
| 6 | 1 | 35.7 | 0.0189 | 0.188 | 0.650 |
| 7 | 1 | 35.7 | 0.0236 | 0.188 | 0.650 |

The above solutions were filtered with a 0.2 micrometer PTFE filter prior to coating to remove dust. Coating was performed in a static air enclosure at ambient humidity and the glass and silicon substrates were cleaned as described above. The substrates were suspended on a clamp attached to a variable-speed coating arm and dip coated. The insertion and withdrawal speeds were ˜0.5 cm/s. The films dried in less than 1 minute. The films were allowed to dry at ambient temperature for 3 days and were calcined at 500° C. for 1 hour.

For the films on silicon substrates, thickness (t_{25° C.}) and refractive index (n_{25° C.}) was measured at 50° and 70°, as described above. Contact angles (CA), refractive indices (n_{500° C.}), and thicknesses (t_{500° C.}) were measured after calcination. The approximate volume percent surfactant in the coating mixture was calculated, as described (in equations 1) above. X-ray diffraction with Cu K_{α} was examined from 0.5 to 60° two theta, as described above. No Bragg peaks were observed for any of the samples.

Thickness, refractive indices, percent porosity, and volume percent surfactant in the coating solution for films on silicon substrates are shown in Table 3.

TABLE 3

| | t_{25° C.} | | t_{500° C.} | | % P at | V % |
|---|---|---|---|---|---|---|
| Sample | (Å) | n_{25° C.} | (Å) | n_{500° C.} | 500° C. | Surf |
| 1 | 3696 | 1.73 | 876 | 1.74 | 37 | 25 |
| 2 | 4117 | 1.69 | 1034 | 1.84 | 31 | 39 |
| 3 | 3828 | 1.87 | 914 | 1.85 | 31 | 57 |
| 4 | 3152 | 1.64 | 1272 | 1.62 | 45 | 72 |
| 5 | 3983 | 1.66 | 1627 | 1.49 | 55 | 80 |
| 6 | 3091 | 1.57 | 2023 | 1.39 | 63 | 84 |
| 7 | 4058 | 1.57 | 2287 | 1.35 | 67 | 87 |

For samples of film on glass, the contact angles of the samples on glass were monitored, after which time photocatalytic testing data was gathered as described above. The samples were stored horizontally on a lab bench, and data are for the side of the film facing up. The sample underwent UV treatment with a blacklamp (˜2 mW/cm²) for 30 minutes. Pencil hardness data were also measured on all of the calcined samples, using the method described above. Data for contact angles, photocatalytic activity, pencil hardness, and X-ray diffraction for films on glass are shown in Table 4.

TABLE 4

| | CA | CA | CA | CA | CA | CA | Photocatalytic | | | |
|---|---|---|---|---|---|---|---|---|---|---|
| | (°) | (°) | (°) | (°) | (°) | (°) | Data | | | |
| | Days | | | | | | | | | |
| | | 3 | 8 | 15 | 15 | 45 | 45 | | | |
| | 1 | Calcined | Uncovered | Uncovered | UV 30 | After | Initial slope | | | XRD |
| | As | (500° C.) | (7 days | (14 days | min (14 | photocatalytic test | (intensity/min) | Pencil | XRD | 20° < |
| Sample | made | (2 days total) | total) | total) | days total) | (44 days total) | (44 days total) | Hardness | 2θ < 5° | 2θ < 60° |
| 1 | 20 | 2 | 10 | 24 | 9 | 10 | 7001 | 2H | — | — |
| 2 | 9 | 3 | 6 | 10 | 8 | 18 | 5943 | 2H | — | — |
| 3 | 8 | 4 | 6 | 15 | 10 | 12 | 5072 | 5B | — | — |
| 4 | 14 | 4 | 5 | 5 | 4 | 16 | 10155 | 5B | — | — |
| 5 | 17 | 4 | 8 | 6 | 5 | 10 | 12046 | <6B | — | — |
| 6 | 18 | 2 | 4 | 5 | 4 | 10 | 12700 | <6B | — | — |
| 7 | 24 | 5 | 5 | 10 | 4 | 11 | 24400 | <6B | — | — |

Note:
— indicates no Bragg peaks in this range.

### Example 2

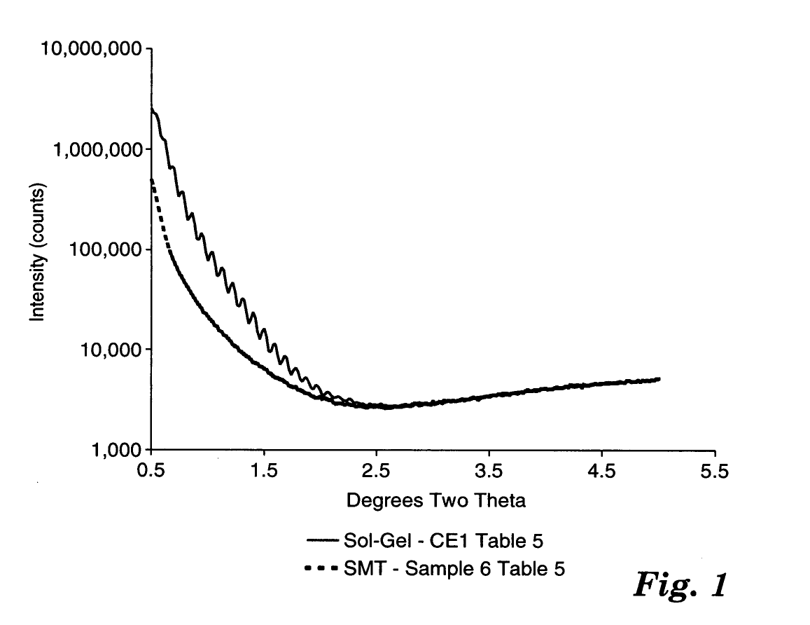

Titanium ethoxide, absolute ethanol, C₁₄TAB, and concentrated hydrochloric acid were mixed in a 250 mL polypropylene bottle in the amounts shown in Table 5. The mixture was stirred at 300 rpm at room temperature prior to coating. The mixtures all formed transparent colorless solutions. Comparative Example 1 was a control sample containing no surfactant. FIG. 1 shows X-Ray diffraction patterns for Sample 6 and Comparative Example 1.

TABLE 5

| | Ti(OC₂H₅)₄ | | | |
|---|---|---|---|---|
| Sample | (mL) | Ethanol (mL) | C₁₄TAB (g) | HCl (mL) |
| Comparative | 7.59 | 77.2 | 0.0 | 0.57 |
| Example (CE)1 | | | | |
| 1 | 7.59 | 77.2 | 0.5 | 0.57 |
| 2 | 7.59 | 77.2 | 1 | 0.57 |
| 3 | 7.59 | 77.2 | 2 | 0.57 |
| 4 | 7.59 | 77.2 | 3 | 0.57 |
| 5 | 7.59 | 77.2 | 4 | 0.57 |
| 6 | 7.59 | 77.2 | 5 | 0.57 |

The molar ratios of the reagents are shown in Table 6.

TABLE 6

| | Ti | Ethanol | C₁₄TAB | HCl | Water |
|---|---|---|---|---|---|
| Sample | (mol) | (mol) | (mol) | (mol) | (mol) |
| CE 1 | 1 | 35.7 | 0.00 | 0.188 | 0.650 |
| 1 | 1 | 35.7 | 0.040 | 0.188 | 0.650 |
| 2 | 1 | 35.7 | 0.081 | 0.188 | 0.650 |
| 3 | 1 | 35.7 | 0.161 | 0.188 | 0.650 |
| 4 | 1 | 35.7 | 0.242 | 0.188 | 0.650 |
| 5 | 1 | 35.7 | 0.323 | 0.188 | 0.650 |
| 6 | 1 | 35.7 | 0.404 | 0.188 | 0.650 |

The above coating solutions were filtered and coated as described in Example 1. The films dried in less than 1 minute. Films 4-6 were slightly hazy immediately after drying. The films were allowed to dry at ambient temperature for 3 days.

For the films on silicon substrates, thickness and refractive index was measured at 50° and 70°, as described above. The films were then calcined at 500° C. for 1 hour. Contact angles, refractive indices, and thicknesses were again measured. The approximate volume percent surfactant in the coating mixture was calculated, as described above. Thickness, refractive indices (70° data), percent porosity, and volume percent surfactant in the coating solution for films on silicon are shown in Table 7.

TABLE 7

| | T_{25° C.} | | t_{500° C.} | | % P at | V % |
|---|---|---|---|---|---|---|
| Sample | (Å) | n_{25° C.} | (Å) | n_{500° C.} | 500° C. | Surf |
| CE 1 | 1648 | 1.77 | 1318 | 2.06 | 40 | 0.0 |
| 1 | 1642 | 1.73 | 1507 | 1.84 | 31 | 0.39 |
| 2 | 1895 | 1.75 | 1562 | 1.86 | 30 | 0.57 |
| 3 | 2704 | 1.64 | 1650 | 1.81 | 33 | 0.72 |
| 4 | 3240 | 1.61 | 1654 | 1.80 | 34 | 0.80 |
| 5 | 3771 | 1.70 | 1738 | 1.74 | 37 | 0.84 |
| 6 | 4026 | 1.54 | 1790 | 1.80 | 34 | 0.87 |

For samples on glass, the contact angles were monitored over 48 days. The films were stored horizontally in a petri dish on a lab bench. The contact angle data are for the side of the sample that was facing up (top) unless otherwise noted. Photocatalytic data was gathered after calcination, as described above. Pencil hardness data were also measured on all of the calcined samples, using the method described above. X-ray diffraction with Cu K_{α} was examined from 0.5 to 60° two theta, as described above. No Bragg peaks were observed for any of the samples. Data for contact angles, photocatalytic activity, pencil hardness, and X-ray diffraction for films on glass are shown in Table 8.

TABLE 8

| | CA (°) | CA (°) | CA (°) | CA (°) | CA (°) | Photocatalytic Data | | | |
|---|---|---|---|---|---|---|---|---|---|
| | Total Days Since Made | | | | | | | | |
| | 1 | 4 | | | | 14 | | | XRD |
| | As | Calcined | 11 | 48 | 48 | Initial slope | Pencil | XRD | 20° < |
| Sample | made | 500° C. | Uncovered | Uncovered | Bottom | (intensity/min) | Hardness | 2θ < 5° | 2θ < 60° |
| CE 1 | 40 | 3 | 3 | 24 | 7 | 46000 | 5H | — | A |
| 1 | 8 | 3 | 3 | 15 | 6 | 54000 | 5B | — | A |
| 2 | 8 | 2 | 3 | 14 | 6 | 60000 | 3B | — | A |
| 3 | 8 | 2 | 3 | 12 | 5 | 46000 | 2B | — | — |
| 4 | 9 | 2 | 4 | 20 | 6 | 60000 | 2B | — | — |
| 5 | 12 | 2 | 5 | 11 | 8 | 59000 | 3B | — | — |
| 6 | 14 | 2 | 2 | 6 | 4 | 43000 | 6B | — | A |

Note:
— indicates no Bragg peaks in this range, A indicates anatase; in all cases the peak was very weak indicating a small fraction of the titania was converted under these conditions.

### Example 3

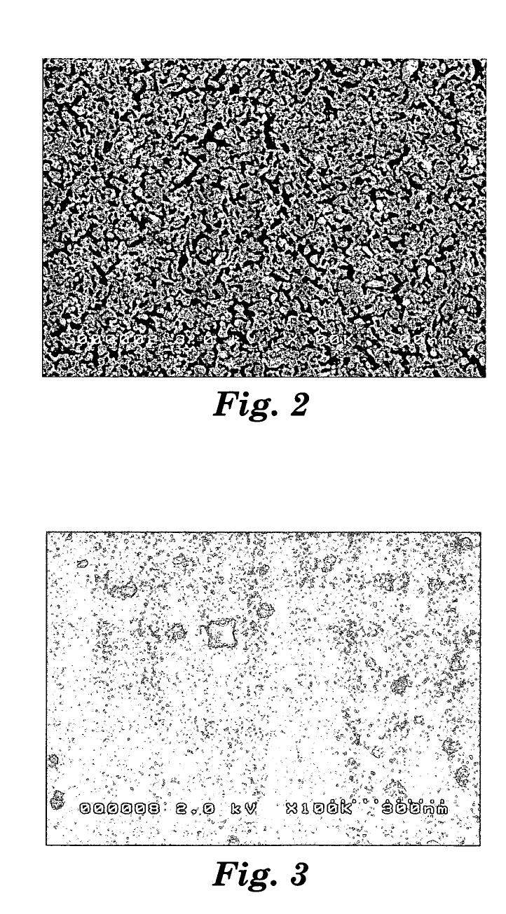

Titanium ethoxide (Aldrich Chemical Company), absolute ethanol, P123, and concentrated hydrochloric acid were mixed in a 250 mL polypropylene bottle in the amounts shown in Table 9. The mixture was stirred at 300 rpm at room temperature prior to coating. The mixtures all formed transparent colorless solutions. CE 2 A-I is a sol-gel sample containing no surfactant. Representative digital images of a high resolution field emission scanning electron micrograph of surfactant-mediated titania and sol-gel formed titania are shown in FIGS. 2 and 3 respectively.

TABLE 9

| | Ti(OC₂H₅)₄ | | | |
|---|---|---|---|---|
| Sample | (mL) | Ethanol (mL) | P123 (g) | HCl (mL) |
| 1 A-I | 7.59 | 77.2 | 4.62 | 0.57 |
| CE 2 A-I | 7.59 | 77.2 | 0.0 | 0.57 |

The molar ratios of the reagents are shown in Table 10.

TABLE 10

| | Ti | Ethanol | P123 | HCl | Water |
|---|---|---|---|---|---|
| Sample | (mol) | (mol) | (mol) | (mol) | (mol) |
| 1 A-I | 1 | 35.7 | 0.022 | 0.188 | 0.650 |
| CE 2 A-I | 1 | 35.7 | 0.00 | 0.188 | 0.650 |

Ten samples each were coated with solution 1 and 2. The above coating solutions were filtered and coated onto the substrates as in Example 1. The films dried in less than 1 minute. The films were allowed to dry at ambient temperature for 1 day. For the films on silicon, thickness and refractive index was measured at 50° and 70°, as described above. The films were then processed at the temperatures shown in Table 11 below. Contact angles (CA), refractive indices (n), and thicknesses (t) were again measured. The approximate volume percent surfactant in the coating mixture was calculated, as described above, and was 86%. Thickness and refractive indices for films on silicon are shown in Table 11.

TABLE 11

| | | t(Å) | t(Å) | n | n |
|---|---|---|---|---|---|
| Sample | Temp (° C.) | 1 | CE 2 | 1 | CE 2 |
| A | Rt | 2930 | 1299 | 1.54 | 1.74 |
| B | 100 | 2991 | 1054 | 1.56 | 1.92 |
| C | 200 | 3178 | 982 | 1.57 | 1.99 |
| D | 250 | 2451 | 941 | 1.37 | 2.02 |
| E | 300 | NA | 894 | NA | 2.00 |
| F | 400 | 1744 | 771 | 1.56 | 1.93 |
| G | 500 | 1566 | 750 | 1.52 | 1.94 |
| H | 650 | 1437 | 647 | 1.58 | 2.11 |
| I | 800 | 1361 | 563 | 1.77 | 2.21 |

For film samples on glass, the contact angles were monitored over 25 days. The films were stored horizontally in a petri dish on a lab bench. The contact angle data are for the side of the sample that was facing up (top) unless otherwise noted. The contact angles for films on glass are shown in Table 12. NT means “not tested”.

TABLE 12

| | CA (°) | CA (°) | CA (°) | CA (°) | CA (°) | CA (°) | CA (°) | CA (°) | CA (°) | CA (°) |
|---|---|---|---|---|---|---|---|---|---|---|
| | 1 | CE 2 | 1 | CE 2 | 1 | CE 2 | 1 | CE 2 | 1 | CE 2 |
| | Total Days Since Made | | | | | | | | | |
| | | | | | 6 | 6 | 15 | 15 | 25 | 25 |
| | 1 | 1 | | | Uncovered | Uncovered | Covered | Covered | After | After |
| | As | As | 2 | 2 | (for 4 days after | (for 4 days after | (for 9 days | (for 9 | photocat- | photocat- |
| Sample | made | made | Calcined | Calcined | calcining) | calcining) | total) | days total) | alytic test | alytic test |
| A | 20 | 25 | 19 | 35 | 11 | 62 | 13 | 72 | — | — |
| B | 22 | 25 | 16 | 54 | 19 | 67 | 15 | 83 | — | — |
| C | 22 | 24 | 10 | 40 | 10 | 58 | 24 | 51 | — | — |
| D | 22 | 23 | 16 | 32 | 31 | 63 | 28 | 52 | — | — |
| E | 22 | 23 | 11 | 14 | 21 | 48 | 18 | 44 | 13 | 39 |
| F | 23 | 25 | 3 | 3 | 5 | 10 | 16 | 20 | 9 | 14 |
| G | 19 | 24 | 1 | 3 | 5 | 7 | 15 | 18 | 7 | 25 |
| H | 22 | 25 | 0 | 1 | 3 | 5 | 13 | 16 | 12 | 26 |
| I | 21 | 29 | NT | NT | NT | NT | NT | NT | NT | NT |

Photocatalytic data was gathered after calcination, as described above. The sample underwent UV treatment with a UVB blacklamp (˜2 mW/cm²) for 30 minutes. Pencil hardness data were also measured on all of the calcined samples, using the method described above. X-ray diffraction with Cu K_{α} was examined from 0.5 to 60° two theta, as described above. No Bragg peaks were observed for any of the samples.

TABLE 13

| | Initial Slope | Initial Slope | Pencil | Pencil |
|---|---|---|---|---|
| | (counts/min) | (counts/min) | Hardness | Hardness |
| Sample | 1 | CE 2 | 1 | CE 2 |
| A | | | <6 B | <6 B |
| B | | | <6 B | 3 B |
| C | | | <6 B | B |
| D | | | <6 B | HB |
| E | 1700 | 3000 | <6 B | F |
| F | 2200 | 2000 | <6 B | 3 B |
| G | 23000 | 1000 | <6 B | 3 B |
| H | 82000 | 26000 | <6 B | 2 H |
| I | No data | No data | <6 B | >9 H |

### Example 4

Titanium ethoxide, absolute ethanol, concentrated hydrochloric acid, 2.16 M TEOS sol, and P123 were mixed in the order listed in a 250 mL polypropylene bottle in the amounts shown in Table 14. The mixture was stirred at 300 rpm at room temperature prior to coating. The mixtures all formed transparent colorless solutions.

TABLE 14

| | Ti(OC₂H₅)₄ | 2.16 M TEOS | Ethanol | P123 | HCl |
|---|---|---|---|---|---|
| Sample | (mL) | sol | (mL) | (g) | (mL) |
| 1 | 7.59 | 0.00 | 77.2 | 4.62 | 0.57 |
| 2 | 6.64 | 2.13 | 77.2 | 4.62 | 0.57 |
| 3 | 5.69 | 4.27 | 77.2 | 4.62 | 0.57 |
| 4 | 3.8 | 8.53 | 77.2 | 4.62 | 0.57 |
| 5 | 1.9 | 12.80 | 77.2 | 4.62 | 0.57 |
| 6 | 0.00 | 17.06 | 77.2 | 4.62 | 0.57 |

Note:
Samples 7-12 are identical to samples 1-6, except they contain 1.00 g P123.

The molar ratios of the reagents are shown in Table 15.

TABLE 15

| | Ti | Si | Ethanol | P123 | HCl | Water |
|---|---|---|---|---|---|---|
| Sample | (mol) | (mol) | (mol) | (mol) | (mol) | (mol) |
| 1 | 1 | 0 | 35.7 | 0.022 | 0.188 | 0.650 |
| 2 | 0.825 | 0.125 | 35.7 | 0.022 | 0.188 | 0.650 |
| 3 | 0.75 | 0.25 | 35.7 | 0.022 | 0.188 | 0.650 |
| 4 | 0.50 | 0.50 | 35.7 | 0.022 | 0.188 | 0.650 |
| 5 | 0.25 | 0.75 | 35.7 | 0.022 | 0.188 | 0.650 |
| 6 | 0 | 1 | 35.7 | 0.022 | 0.188 | 0.650 |

Note:
For samples 7-12 the molar ratios are identical except that the ratio for P123 is 0.0047.

The above coating solution was filtered and then coated onto the substrates as in Example 1. The films were allowed to dry at ambient temperature for 1 day.

For the films on silicon substrates, thickness and refractive index was measured at 50° and 70°, as described above. The films were then calcined at 500° C. for 1 hour. Contact angles, refractive indices, and thicknesses were again measured. The approximate volume percent surfactant in the coating mixture was calculated, as described above. Thickness, refractive indices (70° data), percent porosity, and volume percent surfactant in the coating solution for films on silicon are shown in Table 16.

TABLE 16

| | T_{25° C.} | | t_{500° C.} | | % P at | V % |
|---|---|---|---|---|---|---|
| Sample | (Å) | n_{25° C.} | (Å) | n_{500° C.} | 500° C. | Surf |
| 1 | 4683 | 1.49 | 2090 | 1.39 | 63 | 86 |
| 2 | 3680 | 1.49 | 1100 | 1.79 | 31 | 85 |
| 3 | 3226 | 1.53 | 1489 | 1.69 | 34 | 85 |
| 4 | 3011 | 1.58 | 1315 | 1.64 | 28 | 84 |
| 5 | 2982 | 1.63 | 1599 | 1.54 | 21 | 83 |
| 6 | 3555 | 1.35 | 1747 | 1.35 | 21 | 81 |
| 7 | 2852 | 1.52 | 1099 | 1.79 | 34 | 57 |
| 8 | 2647 | 1.50 | 937 | 1.72 | 36 | 56 |
| 9 | 2772 | 1.56 | 1197 | 1.79 | 27 | 55 |
| 10 | 2631 | 1.45 | 1142 | 1.67 | 25 | 53 |
| 11 | 2157 | 1.48 | 1238 | 1.49 | 27 | 51 |
| 12 | 2077 | 1.42 | 1259 | 1.33 | 25 | 50 |

For samples on glass, the contact angles were monitored over 7 days. The films were stored horizontally in a petri dish on a lab bench. The contact angle data are for the side of the sample that was facing up (top) unless otherwise noted. Photocatalytic data was gathered after calcination, as described above. The sample underwent UV treatment with a UVB blacklamp (˜2 mW/cm²) for 30 minutes. Pencil hardness data were also measured on all of the calcined samples, using the method described above. The data for films on glass are shown below in Table 17.

TABLE 17

| | | | | | Photocatalytic | |
|---|---|---|---|---|---|---|
| | CA (°) | CA (°) | CA (°) | CA (°) | Data | |
| | Total Days Since Made | | | | | |
| | 0 | 1 | 6 | 7 | 14 | |
| | As | Calcined | After | Uncov- | Initial slope | Pencil |
| Sample | made | 500° C. | TPA test | ered | (intensity/min) | Hardness |
| 1 | 17 | 3 | 9 | 9 | 25659 | <6B |
| 2 | 27 | 2 | 14 | 9 | 1193 | 2B |
| 3 | 28 | 2 | 9 | 5 | 860 | 2B |
| 4 | 46 | 1 | 34 | 26 | 256 | 2B |
| 5 | 53 | 1 | 15 | 38 | 346 | 1B |
| 6 | 84 | 1 | 19 | 10 | 259 | 7H |
| 7 | 8 | 2 | 14 | 6 | 9900 | <6B |
| 8 | 27 | 3 | 12 | 6 | 1220 | 1B |
| 9 | 28 | 3 | 9 | 4 | 988 | 2B |
| 10 | 45 | 2 | 22 | 17 | 173 | 1B |
| 11 | 47 | 2 | 4 | 13 | 875 | HB |
| 12 | 55 | 1 | 3 | 4 | 922 | HB |

### Example 5

Titanium ethoxide, absolute ethanol, concentrated hydrochloric acid, 2.16 M TEOS sol, and P123 were mixed in the order listed in a 250 mL polypropylene bottle in the amounts shown in Table 18. The mixture was stirred at 300 rpm at room temperature prior to coating. The mixtures all formed transparent colorless solutions.

TABLE 18

| | Ti(OC₂H₅)₄ | 2.16 M TEOS | Ethanol | P123 | HCl |
|---|---|---|---|---|---|
| Sample | (mL) | (mL) | (mL) | (g) | (mL) |
| 1 | 7.59 | 0.00 | 77.2 | 4.62 | 0.57 |
| 2 | 6.64 | 2.13 | 77.2 | 4.62 | 0.57 |
| 3 | 7.59 | 0.00 | 77.2 | 1.00 | 0.57 |
| 4 | 6.64 | 2.13 | 77.2 | 1.00 | 0.57 |
| 5 | 7.59 | 0.00 | 77.2 | 0.00 | 0.57 |
| 6 | 6.64 | 2.13 | 77.2 | 0.00 | 0.57 |

The molar ratios of the reagents are shown in Table 19.

TABLE 19

| | Ti | Si | Ethanol | P123 | HCl | Water |
|---|---|---|---|---|---|---|
| Sample | (mol) | (mol) | (mol) | (mol) | (mol) | (mol) |
| 1 | 1 | 0 | 35.7 | 0.022 | 0.188 | 0.650 |
| 2 | 0.825 | 0.125 | 35.7 | 0.022 | 0.188 | 0.650 |
| 3 | 1 | 0 | 35.7 | 0.0047 | 0.188 | 0.650 |
| 4 | 0.825 | 0.125 | 35.7 | 0.0047 | 0.188 | 0.650 |
| 5 | 1 | 0 | 35.7 | 0.0 | 0.188 | 0.650 |
| 6 | 0.825 | 0.125 | 35.7 | 0.0 | 0.188 | 0.650 |

The above coating solution was filtered and coated onto substrates as in Example 1. The films dried in less than 1 minute. The films were allowed to dry at ambient temperature for 1 day.

For the films on silicon substrates, thickness and refractive index was measured at 50° and 70°, as described above. The coated films on silicon and glass were calcined at 700° C. for 1 hour. Contact angles, refractive indices, and thicknesses were again measured. The approximate volume percent surfactant in the coating mixture was calculated, as described above. Thickness, refractive indices, percent porosity, and volume percent surfactant in the coating solution for films coated on silicon are shown in Table 20.

TABLE 20

| | t_{25° C.} | | T_{700° C.} | | % P at | V % |
|---|---|---|---|---|---|---|
| Sample | (Å) | n_{25° C.} | (Å) | N_{700° C.} | 700° C. | Surf |
| 1 | 3004 | 1.40 | 1920 | 1.49 | 55 | 86 |
| 2 | 3338 | 1.51 | 948 | 1.79 | 31 | 85 |
| 3 | 2792 | 1.58 | 1026 | 1.95 | 25 | 57 |
| 4 | 3143 | 1.44 | 994 | 1.70 | 39 | 56 |
| 5 | 1795 | 1.66 | 752 | 2.13 | 16 | 0 |
| 6 | 1739 | 1.66 | 739 | 2.08 | 14 | 0 |

For samples on glass, the contact angles were monitored for 15 days. The films were stored horizontally in a petri dish on a lab bench. The contact angle data in Table 21 are for the side of the sample that was facing up (top) unless otherwise noted. Photocatalytic data in Table 21 was gathered after calcination, as described above. The sample underwent UV treatment with a UVB blacklamp (˜2 mW/cm²) for 30 minutes. Pencil hardness data in Table 21 were also measured on all of the calcined samples, using the method described above.

TABLE 21

| | | | Photocatalytic | | | |
|---|---|---|---|---|---|---|
| | CA (°) | CA (°) | Data | | | |
| | Total Days Since Made | | | | | |
| | 1 | 15 | 14 | Pencil | XRD | XRD |
| Sam- | Calcined | Cov- | Initial slope | Hard- | 2θ < | 20° < |
| ple | 500° C. | ered | (intensity/min) | ness | 5° | 2θ < 60° |
| 1 | 3 | 18 | 288000 | <6B | — | A |
| 2 | 5 | 11 | 56000 | F | — | |
| 3 | 10 | 19 | 185000 | 6H | — | A |
| 4 | 5 | 8 | 55000 | HB | — | |
| 5 | 17 | 25 | 255000 | 7H | — | A |
| 6 | 10 | 29 | 11000 | >9H | — | |

### Example 6

A titanium alkoxide (TET—titanium tetraethoxide; TPT—titanium propoxide), absolute ethanol, concentrated or 1% by weight hydrochloric acid, acetic acid (1% by weight in water), deionized water, and P123 were mixed in a 250 mL polypropylene bottle in the amounts shown in Table 22. The mixture was stirred at 300 rpm at room temperature prior to coating.

TABLE 22

| | | | | | 1% | | | |
|---|---|---|---|---|---|---|---|---|
| | | Ti | | | Acetic | | 1% HCl | |
| | | Alk- | Eth- | | Acid in | | in | |
| Sam- | Ti | oxide | anol | P123 | Water | HCl | Water | |
| ple | Source | (mL) | (mL) | (g) | (mL) | (mL) | (mL) | Water |
| 1 | TPT | 5.02 | 53.0 | 1.23 | | 0.34 | | 0.37 |
| 2 | TPT | 5.13 | 54.1 | | | 0.35 | | 0.38 |
| 3 | TPT | 2.37 | 47.9 | 1.67 | 5.43 | | 2.61 | |
| 4 | TPT | 2.44 | 49.3 | | 5.58 | | 2.69 | |
| 5 | TET | 5.33 | 54.2 | | | 0.40 | | |
| 6 | TET | 5.06 | 51.5 | 3.08 | | 0.38 | | |

The molar ratios of the reagents are shown in Table 23.

TABLE 23

| | | | | Acetic | | |
|---|---|---|---|---|---|---|
| | Ti | Ethanol | P123 | Acid | HCl | Water |
| Sample | (mol) | (mol) | (mol) | (mol) | (mol) | (mol) |
| 1 | 1 | 64 | 0.0167 | | 0.29 | 2.45 |
| 2 | 1 | 64 | | | 0.29 | 2.45 |
| 3 | 1 | 136 | 0.048 | | 0.131 | 25.55 |
| 4 | 1 | 136 | | 0.134 | 0.131 | 25.55 |
| 5 | 1 | 45 | 0.0 | 0.134 | 0.232 | 0.81 |
| 6 | 1 | 45 | 0.03 | | 0.232 | 0.81 |

Coating was performed as described in Example 1. The films dried in less than 1 minute. The films were allowed to dry at ambient temperature for 1 day.

The films were then calcined at 500° C. for 1 hour. Contact angles were monitored for 25 days. The films were stored horizontally in a petri dish on a lab bench. The contact angle data are for the side of the sample that was facing down (bottom). The films were exposed to UV radiation twice and the contact angles were measured after each exposure as shown in Table 24. X-ray diffraction was performed on the films. No Bragg peaks were evident, except for a very weak broad feature at ˜150 Å in Sample 1.

TABLE 24

| | CA (°) | CA (°) | CA (°) | CA (°) | CA (°) |
|---|---|---|---|---|---|
| | Total Days since made | | | | |
| | 0.5 | | | | |
| | Calcined | 1 | 7 | 8 | 26 |
| Sample | 500° C. | UV 21 hr | covered | UV 24 hr | covered |
| 1 | 0 | 0 | 7 | 0 | 15 |
| 2 | 0 | 0 | 7 | 20 | 35 |
| 3 | 0 | 0 | 10 | 0 | 12 |
| 4 | 0 | 0 | 11 | 17 | 15 |
| 5 | 0 | 0 | 6 | 0 | 17 |
| 6 | 0 | 0 | 13 | 0 | 8 |

### Example 7

Titanium ethoxide, absolute ethanol, surfactant, and concentrated hydrochloric acid were mixed in a 250 mL polypropylene bottle in the amounts shown in Table 25. The mixture was stirred at room temperature prior to coating. The mixtures all formed transparent colorless solutions.

TABLE 25

| Sample | | Ti(OC₂H₅)₄ | Ethanol | Surfactant | HCl |
|---|---|---|---|---|---|
| (Surfactant) | | (mL) | (mL) | (g) | (mL) |
| 1 | (P123) | 7.59 | 77.2 | 4.62 | 0.57 |
| 2 | (P103) | 7.59 | 77.2 | 4.62 | 0.57 |
| 3 | (10R5) | 7.59 | 77.2 | 4.62 | 0.57 |
| 4 | (C₁₆TAB) | 7.59 | 77.2 | 4.62 | 0.57 |

The molar ratios of the reagents are shown in Table 26.

TABLE 26

| | Ti | Ethanol | Surfactant | HCl | Water |
|---|---|---|---|---|---|
| Sample | (mol) | (mol) | (mol) | (mol) | (mol) |
| 1 (P123) | 1 | 35.7 | 0.022 | 0.188 | 0.650 |
| 2 (P103) | 1 | 35.7 | 0.025 | 0.188 | 0.650 |
| 3 (10R5) | 1 | 35.7 | 0.064 | 0.188 | 0.650 |
| 4 (C₁₆TAB) | 1 | 35.7 | 0.34 | 0.188 | 0.650 |

The above coating solutions were filtered and coated onto substrates as described in Example 1. The films dried in less than 1 minute. The films were allowed to dry at ambient temperature for 1 day. The film made using the solution containing C₁₆TAB was hazy white. The dip speed was slowed to 0.35 cm/min; the coating was still hazy.

For the films on silicon substrates, thickness and refractive index was measured at 50° and 70°, as described above. The films were then processed at 500° C. for 1 hour. Contact angles, refractive indices, and thicknesses were again measured. The approximate volume percent surfactant in the coating mixture was calculated, as described above, and is 86%. Thickness and refractive indices for films on silicon substrates are shown in Table 27.

TABLE 27

| | t_{25° C.} | | t_{500° C.} | | % P at | V % |
|---|---|---|---|---|---|---|
| Sample | (Å) | n_{25° C.} | (Å) | n_{500° C.} | 500° C. | Surf |
| 1 | 3525 | 1.57 | 2074 | 1.37 | 65 | 86 |
| 2 | 3477 | 1.54 | 1718 | 1.45 | 58 | 86 |
| 3 | 3440 | 1.63 | 1251 | 1.60 | 47 | 86 |
| 4 | 3677 | 1.59 | 374 | 1.87 | 29 | 86 |

For samples on glass, the contact angles were monitored over 15 days. The films were stored horizontally in a petri dish on a lab bench. The contact angle data are for the side of the sample that was facing up (top) unless otherwise noted. Data for films on glass are shown in Table 28.

TABLE 28

| | CA (°) | CA (°) | CA (°) | CA (°) | CA (°) |
|---|---|---|---|---|---|
| | Total Days Since Made | | | | |
| | 1 | 2 | 7 | 14 | 14 |
| | As | Calcined | Cov- | Cov- | UV |
| Sample | made | 500° C. 1 hr | ered | ered | 10 min |
| 1 | 21 | 3 | 5 | 15 | 9 |
| 2 | 24 | 3 | 6 | 7 | 4 |
| 3 | 16 | 6 | 4 | 6 | 4 |
| 4 | 16 | 4 | 6 | 4 | 3 |

### Example 8

Titanium ethoxide, absolute ethanol, P123 and concentrated hydrochloric acid, and TiO₂ or SiO₂ nanoparticles were mixed in a 250 mL polypropylene bottle in the amounts shown in Table 29. The mixtures were stirred at room temperature prior to coating. The solutions were spin coated onto silicon wafers and glass slides at 2000 rpm for 30 seconds.

TABLE 29

| | | | | Nanoparticle | | | | V % |
|---|---|---|---|---|---|---|---|---|
| | Ti(OC₂H₅)₄ | TiO2 | SiO2 | Diameter | Ethanol | P123 | HCl | Inorganic |
| Sample | (mL) | (g) | (mL) | (nm) | (mL) | (g) | (mL) | Particles |
| 1 | 2.53 | — | — | 30^{a} | 25.7 | 1.54 | 0.19 | 2 |
| 2 | 2.53 | 2.13 | — | 30^{a} | 25.7 | 1.54 | 0.19 | 2 |
| 3 | 2.665 | — | — | 30^{a} | 27.1 | — | 0.20 | 2 |
| 4 | 2.665 | 2.19 | — | 30^{a} | 27.1 | — | 0.20 | 2 |
| 5 | — | 30 | — | 30^{a} | — | — | — | 100 |
| (control) | | | | | | | | |
| 6 | 2.53 | 2.13 | — | 8^{b} | 25.7 | 1.54 | 0.19 | 17 |
| 7 | 2.665 | 2.19 | — | 8^{b} | 27.1 | — | 0.20 | 16 |
| 8 | 2.53 | 2.13 | — | 9^{c} | 25.7 | 1.54 | 0.19 | 18 |
| 9 | 2.665 | 2.19 | — | 9^{c} | 27.1 | — | 0.20 | 17 |
| 10 | 2.53 | 2.13 | — | 12^{d} | 25.7 | 1.54 | 0.19 | 17 |
| 11 | 2.665 | 2.19 | — | 12^{d} | 27.1 | — | 0.20 | 17 |
| 12 | 2.53 | 2.13 | — | 30^{a} | 25.7 | 1.54 | 0.19 | 2 |
| 13 | 2.665 | 2.19 | — | 30^{a} | 27.1 | — | 0.2 | 2 |
| 14 | 8.00 | | | | 81.4 | 0.00 | 0.60 | |
| 15 | 7.59 | | | | 77.2 | 4.62 | 0.57 | |
| 16 | 8.00 | — | 1.50 | 20^{e} | 81.4 | | 0.60 | 26 |
| 17 | 7.59 | — | 1.50 | 20^{e} | 77.2 | 4.62 | 0.57 | 27 |
| 18 | 3.79 | 3.20 | | 30^{a} | 38.6 | 2.31 | 0.29 | 2 |
| 19 | 4.00 | 3.29 | | 30^{a} | 40.7 | | 0.30 | 2 |
| 20 | 30 (2.16 M | | | | 60 | 8.61 | | |
| | TEOS) | | | | | | | |
| 21 | 30 (2.16 M | | | | 60 | 0.00 | | |
| | TEOS) | | | | | | | |

^{a}Titania-antimony (80/20 w/w) nanoparticles, 1% in water (prepared at 150-200° C. under autogenous pressure as described in U.S. Application No. 09/990,604, filed Nov. 21, 2001);
^{b}Optolake 3 (No. S299015) zirconia-coated anatase (10% solids) from Catalyst and Chemicals Ind. Co., Ltd, Saiwai-Ku, Kawasaki City, Japan;
^{c}Optolake 1 (No. S299013) (9.9% solids) from Catalyst and Chemicals Ind. Co., Ltd, Saiwai-Ku, Kawasaki City, Japan;
^{d}Optolake 2 (No. S299014) tin-seeded rutile (10.9% solids) from Catalyst and Chemicals Ind. Co., Ltd, Saiwai-Ku, Kawasaki City, Japan;
^{e}Nalco 1042 colloidal silica (˜30% solids), Nalco Chemical Co., Naperville, IL.

Note: In Sample 4 the particles started to settle prior to coating.

For Samples 1-13, the films on silicon, refractive indices were measured at 50° and 70°, as described above. The films were then heated at 250° C. for 15 minutes and refractive indices remeasured. The films were heated at 500° C. for 1 hour on the third day. Contact angles, refractive indices, and thicknesses were measured. The samples were allowed to sit for one additional week covered and contact angles were measured. The samples were treated with UV light for 16.5 hours after an additional week, as described above. Thickness and refractive index data are shown in Table 30; contact angle data are presented in Table 31.

TABLE 30

| | | | ^{t}500° C. | |
|---|---|---|---|---|
| Sample | ⁿ25° C. | ⁿ250° C. | (Å) | ⁿ500° C. |
| 1 | 1.38 | 1.53 | 1393 | 1.60 |
| 2 | 1.58 | 1.37 | 1483 | 1.54 |
| 3 | 1.83 | 1.82 | 736 | 1.76 |
| 4 | 1.86 | 1.82 | 896 | 1.79 |
| 5 | 1.85 | 1.62 | 336 | 1.69 |
| 6 | 1.90 | 1.52 | 2033 | 1.42 |
| 7 | 1.75 | 1.75 | 885 | 1.88 |
| 8 | 2.17 | 1.46 | 1818 | 1.41 |
| 9 | 1.75 | 1.76 | 780 | 1.90 |
| 10 | 1.88 | 1.76 | 1485 | 1.50 |
| 11 | 1.75 | 1.73 | 846 | 1.90 |
| 12 | 1.59 | 1.66 | 1415 | 1.49 |
| 13 | 1.63 | 1.78 | 618 | 1.90 |

TABLE 31

| | CA (°) | CA (°) | CA (°) | CA (°) | CA (°) |
|---|---|---|---|---|---|
| | Total Days Since Made | | | | |
| | | | | 10 | 10 |
| | | | 3 | Covered | UV 16.5 hr |
| | | | Calcined | (7 days | (7 days |
| | 0 | 1 | 500° C. 1 hr | after | after |
| Sam- | As | Calcined | (2 days | calcining | calcining |
| ple | made | 250° C. 15 min | total) | 500° C.) | 500° C.) |
| 1 | 21 | 9 | 12 | 8 | 5 |
| 2 | 22 | 10 | 5 | 6 | 5 |
| 3 | 43 | 28 | 8 | 10 | 3 |
| 4 | 29 | 20 | 6 | 10 | 2 |
| 5 | 11 | 13 | 9 | 8 | 6 |
| 6 | 21 | 7 | 9 | 7 | 3 |
| 7 | 12 | 49 | 5 | 7 | 3 |
| 8 | 19 | 8 | 5 | 9 | 4 |
| 9 | 29 | 23 | 17 | 6 | 4 |
| 10 | 18 | 10 | 3 | 6 | 6 |
| 11 | 27 | 22 | 24 | 15 | 3 |
| 12 | 15 | 9 | 4 | 12 | 4 |
| 13 | 6 | 26 | 5 | 26 | 3 |

For Samples 14-17, the films on silicon substrates, thickness and refractive indices were measured at 50° and 70°, as described above. The films were then heated at 250° C. for 1 hour and thickness and refractive indices were re-measured. The samples were allowed to sit for 4 days and contact angles were measured. The samples were treated with UV light for 16.5 hours as described above. Thickness and refractive index data are shown in Table 32; contact angle data are presented in Table 33.

TABLE 32

| | | | ^{t}250° C. | |
|---|---|---|---|---|
| Sample | ^{t}25° C. | ⁿ25° C. | (Å) | ⁿ250° C. |
| 14 | 1710 | 1.76 | 1180 | 1.90 |
| 15 | 1809 | 1.62 | 1915 | 1.48 |
| 16 | 1813 | 1.85 | 1567 | 1.72 |
| 17 | 1629 | 1.65 | 1705 | 1.44 |
| 18 | 1840 | 1.51 | 1465 | 1.48 |
| 19 | 1463 | 1.92 | 1098 | 1.93 |
| 20 | 1997 | 1.40 | 1992 | 1.45 |
| 21 | 2188 | 1.46 | 2811 | 1.42 |

TABLE 33

| Sample | | | | |
|---|---|---|---|---|
| Total | | CA (°) | | |
| Days | CA (°) | 3 | CA (°) | CA (°) |
| Since | 1 | Calcined | 7 | 8 |
| Made | As made | 250° C. 1 hr | Uncovered | UV 16.5 hr |
| 14 | 26 | 20 | 62 | 10 |
| 15 | 18 | 7 | 13 | 13 |
| 16 | 14 | 14 | 58 | 2 |
| 17 | 20 | 6 | 5 | 3 |
| 18 | 13 | 12 | 18 | 9 |
| 19 | 17 | 14 | 54 | 8 |
| 20 | 54 | 17 | 13 | 16 |
| 21 | 73 | 47 | 35 | 39 |

Several of the samples on glass slides were tested with a Taber abrader, which uses ˜1 cm wide abrasive wheel on an arm, loaded with a fixed weight. Samples were affixed to a transparent square plastic 3 inches×3 inches substrate that had a hole in the center. The samples were then placed on the abrader apparatus and allowed to rotate for up to 1160 cycles. Haze (that is, light attenuation) was measured at several intervals with a Haze Meter. Data are shown in Table 34. The data show that the films were completely removed after <100 cycles.

TABLE 34

| | % | % | % | % | % | % | % |
|---|---|---|---|---|---|---|---|
| | Haze | Haze | Haze | Haze | Haze | Haze | Haze |
| | cycles | | | | | | |
| Sample | 0 | 10 | 20 | 40 | 80 | 160 | 1160 |
| 1 | 9.7 | 19.6 | 18.2 | 14.3 | 11.2 | 9.7 | 11.4 |
| 3 | 4.1 | 4.5 | 4.9 | 5.7 | 6.5 | 7.7 | 5.5 |
| 6 | 2.6 | 16.0 | 12.4 | 6.4 | 4.3 | 4.2 | 4.6 |
| 12 | 4.8 | 14.3 | 10.5 | 12.2 | 8.6 | 8.1 | 8.6 |
| 13 | 3.3 | 7.3 | 6.8 | 5.7 | 4.1 | 3.8 | 4.9 |
| 17 | 2.5 | 5.7 | 4.9 | 4.5 | 4.7 | 4.7 | 5.5 |
| 18 | 3.2 | 14.2 | 8.8 | 5.1 | 4.1 | 4.1 | 4.7 |
| 19 | 65.1 | 38.8 | 38.5 | 37.7 | 39.1 | 39.2 | 38.4 |
| 20 | 6.2 | 8.6 | 5.2 | 4.1 | 5.6 | 4.5 | 6.4 |

### Comparative Example 3

P123 (1 g) and absolute ethanol (10 g) was added to a 20 mL glass vial and stirred for ˜45 minutes to dissolve the surfactant. After cooling, TiCl₄ (1.1 mL) was added slowly and formed a transparent yellow solution. The molar ratios of reagents were: 1 Ti: 18.7 ethanol: 0.019. The solution was heated to 30° C. for 10 minutes and then coated onto a silicon wafer and a glass slide. The solution was spin-coated at 2000 rpm for 30 seconds. Contact angles were measured on the as-made sample, after heating at 250° C. for 15 minutes and after heating at 500° C. for 1 hour. The contact angles were 36°, 10°, and 34°, respectively.

All patents, patent applications, and publications cited herein are each incorporated by reference, as if individually incorporated.

1. A method of making a surface of an article superhydrophilic comprising the steps of:
providing a surfactant mediated metal oxide film precursor comprising an alkoxide of titania, cationic or nonionic surfactant, and acid catalyst;
coating said precursor onto the surface of an article;
drying said precursor; and
removing the surfactant.

2. The method of claim 1 wherein the surfactant is removed by heating the coated article at a temperature of from about 200 to about 850° C.

3. The method of claim 1 wherein the precursor further comprises an alkoxysilane.

4. The method of claim 1 wherein the precursor further comprises nanoparticles.

5. The method of claim 1 wherein the surfactant is selected from the group consisting of: alkylammonium salts having the formula: CₙH₂ₙ₊₁N(CH₃)₃X, where X is OH, Cl, Br, HSO₄ or a combination of OH and Cl, and where n is an integer from 8 to 22; CₙH₂ₙ₊₁N(C₂H₅)₃X, where X is OH, Cl, Br, HSO₄ or a combination of OH and Cl, where n is an integer from 12 to 18; surfactants having the formula: (C₁₆H₃₃N(CH₃)₂)₂ CₘH₂ₘ2X, where X is OH, Cl, Br, HSO₄ and wherein m is an integer from 2 to 12; cetylethylpiperidinium salts having the formula: C₁₆H₃₃N(C₂H₅)(C₅H₁₀)X, where X is OH, Cl, Br, HSO₄ or a combination of OH and Cl; poly(ethylene oxides), (octaethylene glycol) monododecyl ether, (octaethylene glycol) monohexadecyl ether; poly(ethylene oxide)-poly(propylene oxide)-poly(ethylene oxide) triblock copolymers; poly(propylene oxide)-poly(ethylene oxide)-poly(propylene oxide) triblock copolymers; and combinations thereof.

6. The method of claim 1 wherein the surfactant is selected from the group consisting of: poly(ethylene oxides), (octaethylene glycol) monododecyl ether, (octaethylene glycol) monohexadecyl ether, poly(ethylene oxide)-poly(propylene oxide)-poly(ethylene oxide) triblock copolymers, poly(propylene oxide)-poly(ethylene oxide)-poly(propylene oxide) triblock copolymers and combinations thereof.

7. The method of claim 1 wherein the surface of the article is selected from the group consisting of metals, painted metals, glass, ceramics, plastics, and wood.
